(19) United States
(12) Patent Application Publication
(10) Pub. No.: US 2007/0236384 A1
(43) Pub. Date: Oct. 11, 2007

(54) Cost-effective friend-or-foe (IFF) combat infrared alert and identification system (CID)

(76) Inventors: Gennadii Ivtsenkov, Hamilton, CA (US); Alexandre Mantsvetov, Burlington, CA (US); Evgeny Berik, Tartu (EE)

Correspondence Address: GENNADII IVTSENDOV, 386 REXFORD DRIVE, HAMILTON, ON, L8W3Y7, CA

(21) Appl. No.: 11/685,682

(22) Filed: Mar. 13, 2007

(30) Foreign Application Priority Data
Feb. 12, 2006 (CA) 2549727

(51) Int. Cl. G01S 13/78

(52) U.S. Cl. 342/45

(57) ABSTRACT

A compact and cost-effective infrared IFF alert system for small arm based on fiber-optical (FO) technology, comprising an optical interrogator and an optical transponder, is provided. The interrogator attached to a small arm, such as a rifle, includes a FO laser diode and FO receiver, which are connected to FO graded-index lens attached to sight of the small arm via a single-mode optic fiber, an electronic unit positioned in any convenient place of the small arm, and an alarm LED attached to the sight together with the lens. The transponder, which “a friendly target”—a soldier—is equipped with, contains a set of transmitter-receiver unit and an electronic unit that are mounted on a harness attached to soldier's helmet. This IFF system, when a friendly soldier is targeted, starts visual alarm signal for the shooter and sound signal for the “friendly target” so preventing “friendly fire”.

### CROSS-REFERENCE TO RELATED APPLICATIONS

This application is a continuation of U.S. Provisional Application No. 60/767,091 and Canadian Patent Application No 2,549,727 filed Jun. 12, 2006.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATED-BY-REFERENCE OF MATERIAL SUBMITTED ON A COMPACT DISK

Not Applicable.

### BACKGROUND OF THE INVENTION

1. Field of the Invention

The invention relates to military friend-or-foe identification (IFF) systems. More specifically, the present invention is related to military small arms IFF systems to determine in battlefield conditions whether or not a selected target is a friendly target. Still more specifically, this invention is directed to IFF system in which the friendly target is equipped with light receiver and light source that, being activated, emits the encrypted infrared (IR) signal, which may be detected by a shutter to avoid a friendly fire.

2. Description of the Related Art

The events on the battlefield become more and more complex and take place at increasing speed. The last evidences from battlefields show the increase of losses caused by so-called “friendly fire”. Because of this, one of the most important information from the battlefield is actually the determination of whether or not an object or a person is hostile.

The number of advanced IFF systems has been developed for the identification of aircraft and some other large devices involved in combat operation. The problem of identifying individual soldiers in battlefield conditions are still unsolved to a large degree, but are all the more pressing, because in modern combat operations, where soldiers are involved less in short range combat, can no longer be distinct by their clothing or insignia. Therefore, equipping ground troops with IFF systems can save many lives.

There are a number of patents dealing with IFF systems utilizing radio transmitter-receiver units or combination of optical receiver and RF transmitter ones, such as U.S. Pat. No. 3,104,478 issued to Strauss et al. Sep. 24, 1963, U.S. Pat. No. 3,400,393 issued to Saul H. et al. Sep. 3, 1968, U.S. Pat. No. 4,862,176 issued to Voles Aug. 29, 1989, U.S. Pat. No. 4,899,093 issued to Taylor, et al. Feb. 6, 1990 and U.S. Pat. No. 5,929,777 issued to Reynolds July 27, 1999. In these systems a soldier is equipped with RF or optically activated units that send coded RF responses. Such systems have obvious disadvantages that cannot allow successful implementation on the battlefield. One of them is the possibility of RF signals jamming in highly interfering environments. Another serious disadvantage is the wide directional pattern of receiver and transmitter antennas. Because of this, IFF response can be received from a number of soldiers simultaneously, and a sender cannot recognize which soldier is responding.

Other IFF systems claimed in a number of patents, such as U.S. Pat. No. 3,989,942 issued to Waddoups Nov. 2, 1976, U.S. Pat. No. 4,134,008 issued to Corlieu Jan. 9, 1979 and U.S. Pat. No. 4,763,361 issued to Honeocutt, et al. Aug. 9, 1988 utilize optical transmitters mounted on a rifle and a retroreflector sign or optic device mounted on soldier's harness. The obvious disadvantage of such systems is disclosure of a soldier's position by any laser system, so a soldier becomes an easy target. There are some improvements of this system described, for example, in U.S. Pat. No. 5,459,470 issued to Wootton Oct. 17, 1995, where the retroreflector aperture closed by a modulator opens the retroreflector aperture when the system receives the signal. Such a solution drastically diminishes the system sensitivity because of laser beam divergence, and losses caused by the small aperture of this kind of retroreflector. Therefore, such a system requires the utilization of a high power laser in the sender's transmitter to achieve a range of hundreds meters.

There is another kind of optical IFF system for small arms—an active one that comprises optical transmitting-receiving unit mounted, for example, on the rifle, and similar unit mounted on a friendly target. In particular, such system is described in U.S. Pat. No. 6,439,892 issued to Gerber Aug. 27, 2002. Here, a soldier carries a weapon on which a laser device is mounted, which is used for illuminating a harness device on the body of another soldier. This harness device is provided with a number of optical sensors and LEDs sending response signals. According to this patent, the laser device transmits a tightly bundled laser beam of 0.2-milliradian divergence that illuminates a 4-cm diameter spot on the distance of 100 meters. Also, the author of this patent proclaims a general idea that LED mounted on the harness has to be a high power one and emit light on a wide angle. He suggests 780-905-nm wavelength for illuminating and response lasers (LEDs). According to research and calculation performed by the authors of the present invention, the system proposed in U.S. Pat. No. 6,439,892 has a number of disadvantages that are explained below. Calculation performed by the authors of the present invention reveal that, indeed, only active optical IFF system comprising laser transmitters installed on a small arm and target can provide the range exceeding a few hundreds meters, that is essential for combat involving small arm fire. Particularly, NATO assault rifle M-16 has an aiming distance of 500-600 meters, therefore IFF system specified for such weapon has to work in the range of tens meters to about 500 meters. Also, it could be some additional requirements providing efficiency of such IFF system on a battlefield. For example, the laser transmitter installed on a rifle has to emit sharp beam, but the light spot has to be wide enough to illuminate optical receiver(s) mounted on helmet or uniform of the soldier. The laser beam with divergence of 4 milliradians illuminates circles of 2-meter diameter at 500-meter distance and 0.2-meter diameter at 50-meter distance. Such beam divergence is close to the optimal one, because a wider beam could illuminate a few targets simultaneously causing inappropriate responses, and, also, diminishing security of this system. From another hand, a narrow beam, particularly proposed in mentioned above U.S. Pat. No. 6,439,892, will in many cases miss the sensor, especially on short distance (4-cm spot at 100 meters), so IFF detection will be failed. Also, the beam divergence together with sensitivity of the sensor installed on the target determines the range where the beam emitted by the laser can be detected. For example, the optical signal sent by the laser having 4-milliradian divergence and captured by 8-mm diameter lens will attenuate by 45 dB at 500-meter distance. If the laser provides 1-milliwatt output, the signal will have power of −45 dBm that is suitable for fiber-optical telecommunication receivers further proposed in the present invention.

Wavelength of 800-900 nm suggested in U.S. Pat. No. 6,439,892 in the combination with a high power laser emitting a sharp beam can permanently or temporarily blind the illuminated soldier, because near-wavelength infrared exposure (lambda <1000 nm) may focus on the retina, causing burns. Infra-red (IR) radiation with longer wavelength is not transparent for human eyes, so it cannot be focused on the retina. The only damage could be caused by a high energy doze (not power) of IR exposing external tissue of the eye. Because of this, the wavelengths suggested in the present invention are the ones utilized in fiber-optical telecommunication lines—1310 nm and 1550 nm. Moreover, such telecommunication laser transmitters, receivers and associated electronics are very well developed, cheap and widely available on the market.

Proposed in U.S. Pat. No. 6,439,892 design of optical-electronic unit (FIG. 2 of this patent) is a bulky one and overloaded with elements, such as display, hologram plate, a few operational buttons, etc. that could be suitable for combat simulation, but can confuse a soldier in real battlefield conditions. Because such a large device has to be mounted on the sight of a small arm (rifle), it could require the redesign of large number of rifles. Utilization of fiber-optical line optically connected (pigtailed) to IR telecommunication laser or novel 1550-nm pulsed laser diode and fiber-optical graded-index lens is proposed in the present invention. Utilization of modern fiber-optic (FO) technology allows simultaneous (duplex) transmitting request signals and receiving response signals using just single graded-index lens pigtailed with single-mode optic fiber—the preferred embodiment of the present invention. Such a solution allows only fastening a small cylindrical (about 8×20 mm) lens on the sight that can follow the sight adjustment, wherein an immobile miniature electronic unit with built-in FO laser, FO detector, drivers and associated electronics can be attached to the rifle in any convenient place; and this lens—the only movable element—will be connected to the unit via a length of single-mode optical fiber.

When the target is detected as a friendly one, the unit mounted on the small arm has to take some action to prevent the friendly fire. In some patents, such as U.S. Pat. No. 6,664,915 issued to Britton Dec. 16, 2003, authors proposed a disarming device. For small arms such a solution seems inappropriate, because, in the case when the “friendly target unit” is captured and used by an enemy soldier, this soldier becomes “untouchable”. Therefore, the present invention proposes a simple optical alarm signal visible to the shooter (it can be a red LED mounted on the sight together with the lens) forcing him to make a fast decision, because utilization of more complicated alarm system can confuse a soldier in real battlefield conditions.

All patents mentioned above propose different kinds of signal coding, such as pulse coding, wavelength coding, etc. The present invention proposes periodically updated 64-128-bit pulse coding that can be easily performed by microchip-driven FO laser. In the case when enemy forces are unequipped with descrambling devices, the code could be simplified with updating time of a few days; and this time could be shortened to a few hours when such devices are in use. Such update can be, for example, preformed by “blue tooth” short range wireless port installed in the shooter's unit and the friendly target unit.

### SUMMARY OF THE INVENTION

The present invention alleviates the disadvantages of the prior art by means of utilization of elements of FO technology that had been developed for novel FO telecommunication lines. Such an approach allows creating a miniature and cost-effective IFF alarm system for small arms, such as rifle, machine gun, propelled grenade launcher, etc. The system proposed in the present invention does not require any modification of the existed weapon and can be attached to different kinds of small arms. Nanosecond pulses of 1310-nm and 1550-nm infrared laser radiation proposed in the present invention is the “eye safe” one because such radiation is not focused on retina. Also, radiation of these wavelengths is not visible for night vision devices so providing security of IFF procedure. Light and sound alarms installed in the “request” and “response” units allow reliably avoiding “a friendly fire”.

Another embodiment of the present invention—the battlefield identification and alarm system that is attached to conventional field observation devices, such as binoculars, night vision devices, electro-optical sights, etc. allows remotely estimating a battlefield situation by retrieving information stored in memory of a “response unit”, which an individual soldier—a “friendly target”—is equipped with. That information can include the health condition of the soldier obtained by sensors attached to soldier's skin and sent by the optical line appearing when this battlefield identification and alarm system activates the “friendly target unit”. This embodiment comprises the same solutions that were utilized in the previous embodiment—the IFF alarm system for small arms; moreover the “response unit” can be unified and used in both embodiments.

### THE DRAWINGS

FIG. 1 depicts the diagram—the schematic diagram of IFF system of the preferred embodiment of the present invention.

FIG. 2 depicts the schematic diagram of the interrogator of IFF system of the preferred embodiment.

FIG. 3 depicts the schematic diagram of the transponder of the preferred embodiment.

FIG. 4 depicts the detailed block diagram of the transponder of the preferred embodiment.

FIG. 5 depicts the optical scheme of the transmitters (shown for 10 receiving-transmitting optical units) of the transponder of the preferred embodiment.

FIG. 6 depicts the schematic diagram of another embodiment of the transponder utilizing photonic switch.

FIG. 7 depicts another embodiment of the present invention—a combat identification and alert system.

FIG. 8 depicts the diagram of the interrogator of the combat identification and alarm system of this embodiment.

FIG. 9 schematically depicts position of the “health monitoring sensor” of the transponder of this embodiment.

### DETAILED DESCRIPTION OF THE PREFERRED EMBODIMENTS OF THE INVENTION

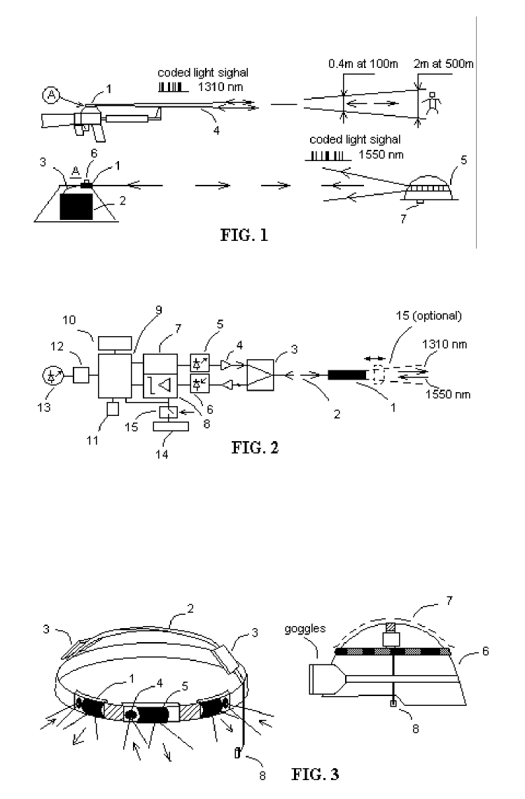

The schematic diagram of IFF system of the present invention is depicted in FIG. 1.

Here, a small arm, such as M-16 assault rifle is equipped with an optical request unit-interrogator, which comprises a small graded-index cylindrical lens 1 mounted (attached) on the sight of the rifle and optically connected to an optical-electronic unit 2 via optical fiber 3. This request unit sends optical coded signal, which is received by an optical-electronic response unit-transponder 5 which a friendly target—a soldier—is equipped with. When this optical signal is received, the transponder 5 sends a coded optical response signal to the request unit; this signal that reaches the interrogator and, being decoded, activates the simple optical alarm signal 6 (just a flashing red LED mounted on the sight together with the lens 1) telling the shooter that “it is a friendly target”. Also, the optical signal received by the transponder 5 simultaneously activates a distinctive sound signal (sounded by a headphone or buzzer) that informs the soldier that “he could be under friendly fire”. The time of bullet flying on the distance of 500 meters is about 0.7-1 second that gives a trained soldier the time to avoid the shot.

In this embodiment the laser transmitter of the interrogator installed on a rifle has to emit a sharp beam, but the light spot has to be wide enough to illuminate optical receiver(s) mounted on helmets or uniforms of the soldier. This embodiment proposes the laser beam with divergence of 4 milliradians (controlled by the lens 1) that illuminates circle of 2-meter diameter at 500-meter distance and 0.2-meter diameter at 50-meter distance. Such beam divergence is close to the optimal one, because a wider beam could illuminate a few targets simultaneously causing false alert, and, also, diminishing security of this system, but a very narrow beam (proposed in some mentioned above patents), in many cases, could miss the sensor, especially on short distances, so IFF detection will fail. To completely eliminate this problem, the lens 1 of this embodiment can be optionally equipped with mechanical zoom containing movable lens (position 14 on FIG. 2), which enlarges the light spot and receiving area size up to 1 meter on small distances (less than 100 meters). Because the single lens 1 is utilized in this embodiment to transmit request signal and receive response one, the request unit illuminates and receives the signal from the same small area (2 meters on 500-m distance) limited by angular aperture of the lens 1; so, it can not receive any optical signal coming from another direction.

Proposed in this embodiment wavelengths emitted by lasers of the units are the ones utilized in fiber-optical (FO) telecommunication lines—1310 nm and 1550 nm, because such telecommunication laser transmitters, receivers and associated electronics are very well developed, cheap and widely available on the market. Moreover, radiation of these wavelengths is safe to the human eye, because, unlike the wavelength shorter than 1000 nm, it is not transparent for human eye, so it can not be focused on the retina.

The present invention proposes periodically updated 32-128-bit pulse coding that can be easily performed by the microchip-driven FO laser. In the case when enemy forces are unequipped with descrambling devices, the updating time could be a few days; and this time is shortened to a few hours when such devices are in use. This update can be, for example, performed by “blue tooth” short range wireless port installed in the shooter's unit and the friendly target unit.

The zoom lens 15 (optional) allows enlarging the beam diameter up to 1 meter on 50-meter distance.

### Another Embodiment of the Invention

Another embodiment of the invention comprises interrogator containing two separate channels—transmitting and receiving ones. In this embodiment the interrogator contains two lenses—the transmitting one with 1-mm aperture, and receiving one having larger aperture that increases sensitivity of the receiver. It allows the system reliably working in rainy, fogy and dusty atmospheric conditions, which produce attenuation for IR signal. In this embodiment, these two lenses is installed on the sight of the small arm and connected to the optical-electronic unit 2 via two length of optical fiber. This embodiment, also, allows simplifying the optical-electronic unit eliminating direction-separating elements, such a fiber-optical circulators and isolators.

Detailed Description of the Request Unit (Interrogator) of the Preferred Embodiments of the Invention

The schematic diagram of the request unit of IFF system of the present invention is depicted in FIG. 2.

The unit consists of two parts—a graded-index FO lens 1 attached to a sight of small arm (see FIG. 1) and an optical-electronic unit, which contains FO splitter/combiner 3, two FO isolators 4, transmitting FO laser diode (LD) 5, FO receiver 6, driver of the FO LD 7, amplifier-former 8, processor-coder/decoder 9, flush memory 10, “blue tooth” port 11, amplifier 12, alarm LED 13, lithium battery-power source 14 and start button 15 attached to the rifle's trigger; wherein the lens 11 is optically connected to the optical-electrical unit (to FO splitter 3) via optical fiber 2.

The unit works as follows:

When a soldier (shooter) touches the trigger, it switches the unit on. The processor 9, according to program written in the flush memory 10, develops package of coded electrical pulses, which is transformed by the driver 7 into electric pulses feeding the LD 5. The length of the package can be about 1 microsecond, and it can contain 128-bit ID code. The laser diode 5 converts the electric pulses into modulated optical 1310-nm or 1550-nm radiation that is transmitted to collimating lens 1 via the single-mode optic fiber 2. The lens 1 collimates the radiation in a sharp beam that illuminates the target. The response unit attached to helmet of “friendly target”—a soldier sends modulated optical 1550-nm IR signal that is received by the lens 1 and transmitted to the optical-electrical unit via the optic fiber 2. This signal is transformed by FO receiver 6 into electrical pulses, which are amplified and transformed into TTL pulses by the amplifier-former 8. The pulses carrying the coded message “friendly target” are further decoded by the processor 9 and compared with the code written in the memory 10. If the codes are the same, the processor 9 starts the alarm LED 13. The program and codes written in the memory 10 can be updated via wireless “blue tooth” or wired USB port 11. To automatically update the code, the USB port is connected to a commander computer. In the case of manual updating, the port is connected to miniature keyboard.

Detailed Description of the Response Unit (Transponder) of the Preferred Embodiments of the Invention

The schematic diagram of the response unit of IFF system of the present invention is depicted in FIG. 3.

The unit consists of two parts—a number of receiving-transmitting optical units 1 attached to a belt of harness 2 (position 5 on FIG. 1) and electronic processing units 3 also mounted on the harness. Each optical unit 1 contains an optical receiver 4 and optical transmitter 5, wherein they are electrically connected to the electronic units 3. The harness 2 is attached to the soldier's helmet 6 and can be protected by a metal or plastic shield 7 (optional). The electronic unit 3 is electrically connected to the alarm buzzer 8, which sounds when the soldier is targeted.

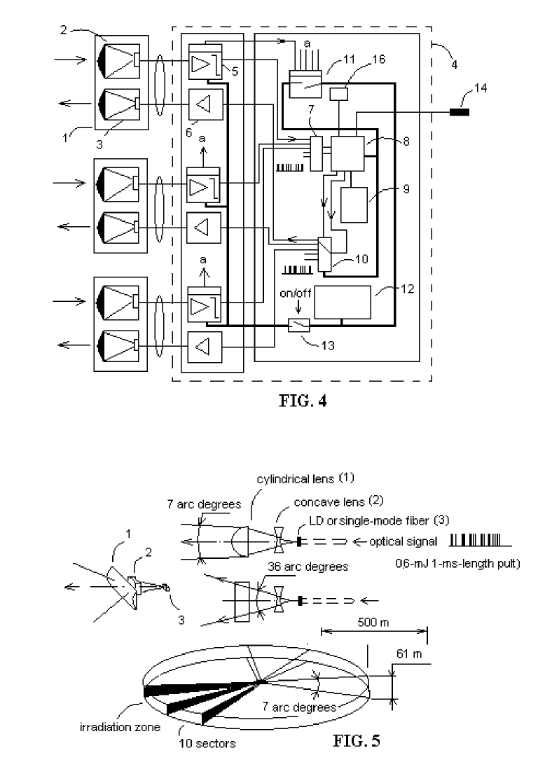

The detailed block diagram of the transponder unit is depicted in FIG. 4. The unit is comprised of an optical assembly consisting of a number of separated receiving-transmitting optical units 1 attached to the belt of harness (position 5 on FIG. 1), wherein each of them contains optical receiver 3 and transmitting laser diode (LD) 3 equipped with receiving and transmitting lenses. These optical units are electrically connected to the electronic processing unit 4 (position 3 on FIG. 3) via electric cable. The unit 4, also, can be separated on a few parts attached to the harness and connected together via electrical lines as shown on FIG. 3. The electronic processing unit 4 contains a set of the laser diode drivers 6 and amplifier-formers 5, wherein each driver is in electrical connection and exclusively dedicated to the individual laser diode 3 installed in the unit 1; and each amplifier-former 5 is in electrical connection and exclusively dedicated to the individual optical receiver 2 installed in the unit 1. One output of each amplifier-former 5 is connected to one logical input of electronic switch 11, and another output—to one input of logical element 7, wherein the switch 11 activates the main elements of the unit, when an electrical signal appears on output of any optical receivers 2. Logical element 7 detects the receiver 2 where the signal appears and transmits it to the processor 8 that decodes received signal and, if the code is matched with the code written in flash memory 9 and identified as “friendly”, the processor 8 generates the coded response signal. This signal enters electrical switch 10 that transmit this signal to the driver 6 of the receiving-transmitting optical units 1, which receives the signal, and the laser diode 3 sends the optical signal to the interrogator unit mounted on the rifle. Also, when the received signal was identified as “friendly” the processor 8 activates alarm buzzer 14. All receivers 2 and amplifier-formers 5 together with the switch 11 are permanently switched on when the soldier presses “on/off” button 13, whereas, to save energy of lithium battery 12, other elements are not activated and energized only when the request optical signal appears.

Contents of the flush memory 9 can be updated via wireless “blue tooth” port 16 (optionally, it could be USB or serial port).

The transponder of this embodiment sends an optical response signal in the same sector from which it receives the request signal. For such purpose it employs a number of receiving-transmitting optical units 1 (see FIG. 3), wherein each of them is responsible for its specific sector in such a way that they provide circular 360-arc degree observation. The optical scheme of the transmitters (shown for 10 receiving-transmitting optical units 1) is depicted in FIG. 5.

Here, each unit (position 1 on FIG. 3) receives request signal and sends response in the sector of φ×ψ arc degrees as depicted in FIG. 5, wherein +is the horizontal (azimuth) angle and ψ is the vertical one. Since the position of the soldier's head is unknown, it can not send the response signal exactly in the same direction from that he received the request. To solve this problem, it is possible to send the response signal within a hemisphere, but it could disclose soldier's position and requires a high power light source. Therefore, the response signal has to be sent in some angular sector. The optical unit of this embodiment comprises a number of optical transmitters covering 360-degrees of horizontal observation. The number of transmitters can vary and depend on exact requirements. FIG. 5 depicts the scheme for 10 such transmitters equally spaced around circumference, so each transmitter emits in 36-degree angle. Because the vertical motion of soldier's head when he looks straight can reach about 7-10 arc degrees, the transmitter has to emit at least in 36×7-arc degree sector, which is formed by special optics (objective lens) of the transmitter. The vertical angle ψ can be enlarged by appropriate combination of lens 1 and 2 to any value (for example—up to 90 arc degrees), but such enlargement requires proportionally higher power of the laser pulse. The objective lens of this embodiment depicted in FIG. 5 contains two components—cylindrical lens 1 and concave lens 2. The laser diode 3 emits radiation in cones of some angle depending on the laser design. The lens 2 widens the cone to 36 arc degrees, and cylindrical lens 2 collimates the beam in vertical direction; so such combination provides required 36×7-arc degree light beam. The optical receiver of this embodiment does not have any specific features and simply covers 36×36-arc degree cone. The optical axes of the transmitter and receiver have to be coaxial.

The optic signal sent by the transponder proposed in this embodiment has 10-millisecond length, and contains sequence of pulse packages carrying the code. The energy of this 1550-nm optic pulse is 1 mj that provides 1-watt power in the pulse. That is enough to detect this signal by optical receiver installed in the request unit (−55 dBm), and such pulse is not dangerous for the human eye. To provide additional 10 dB backup, which is important in poor weather conditions, power of the laser can be increased up to 10 watt in pulse. The most suitable lasers for the transponder are novel 1550-nm high-power pulsed laser diodes (LD) emitting sequences of 100-nanosecond pulses. These LDs provides power of 1-10 watts, they are inexpensive and available on the market.

The number of the optical units (position 1 on FIG. 3) can be higher. In this case, the angular size of the illuminated sector is diminished that provides more security also diminishing the pulse power, but requires more optic and electronic elements.

To protect the optics from water and dirt, the optics has to be periodically cleaned up. Also, it can be protected by any suitable water-repellent coating.

Another Embodiment of the Response Unit (Transponder) of the Present Invention

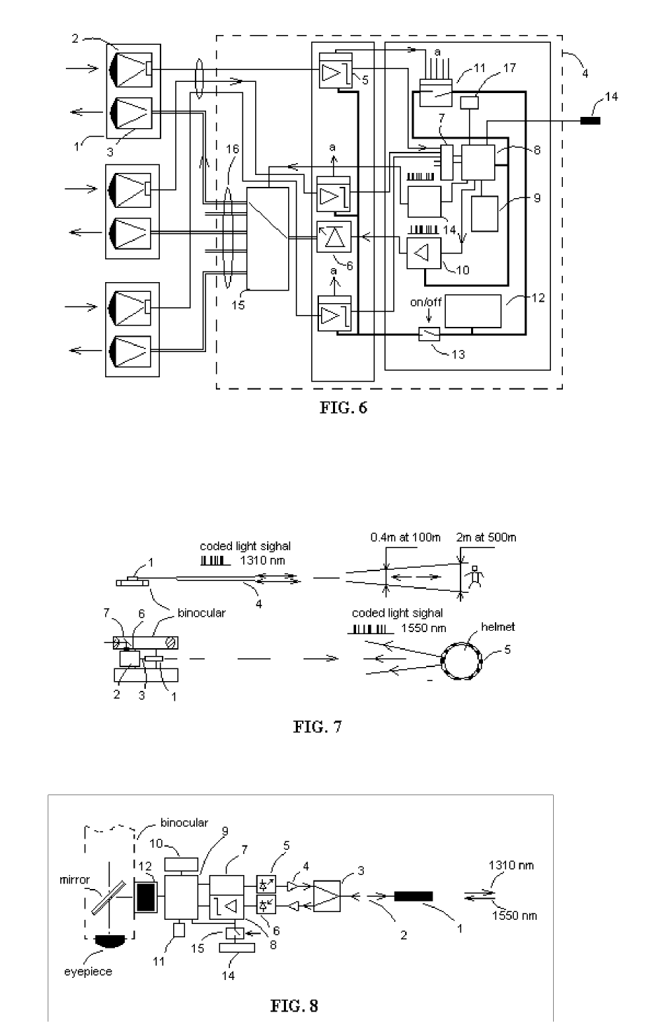

This embodiment is depicted in FIG. 6.

Here, the interrogator (position 5 on FIG. 1) is based on fiber-optical (FO) technology and employs a FO photonic switch, such as multi-port MEMS switch. Such a solution allows using a single FO laser diode with a single electronic driver.

It contains two units connected by electrical and fiber-optical cables—the receiving-transmitting optical units 1 attached to the belt of harness (position 5 on FIG. 1) and electronic-optical unit 4 attached to the same harness. Each of units 1 contains optical receiver 2 and FO lens 3, wherein the receivers electrically connected to the unit 4 via electric cable 18, and the lens 3—via optical cable 16. The electronic-optical unit 4 contains a single laser diode (LD) 5 connected to LD driver 10 and a set of amplifier-formers 5 that pre-amplify electrical pulses received from the receiver 2 and transforms them into TTL pulses, wherein each amplifier 5 is in electrical connection and exclusively dedicated to the individual optical receiver 2 installed in the unit 1. One output of each amplifier-former 5 is connected to one logical input of electronic switch 11, and another output—to one input of logical element 7, wherein the switch 11 connects the main elements of the unit 4 to power supply 12 when an electrical signal appears on output of any optical receivers 2. Logical element 7 detects the receiver 2 where the signal appears and transmits it to the processor 8 that decodes received signal and, if the code is matched with the code written in flash memory 9 and identified as “friendly”, the processor 8 generates the electrical coded response signal and signal controlling MEMS switch 15. This response signal feeds the LD 6 via LD driver 10. LD 6 converts electrical signals onto optical ones that enter MEMS switch 15. The MEMS driver 14 switch optical channel according to the signal that it received from the processor 8; the MEMS switch directs the optical signal generated by LD 6 to lens 3 of the optical unit 1, which received the request signal. So, lens 3 sends the optical signal to the request unit mounted on the rifle. Also, when the received signal was identified as “friendly” the processor 8 activates alarm buzzer 14.

All receivers 2 and amplifier-formers 5 together with the switch 11 are permanently switched on when the soldier presses “on/off” button 13, whereas, to save energy of lithium battery 12, other elements are not activated and energized only when the request optical signal appears.

Contents of the flush memory 9 can be updated via wireless “blue tooth” port 16 (optionally, it could be USB or serial port).

Detailed Description of Another Embodiment of this Invention—an Optical Combat Identification (OCID) and Alert System

This embodiment is depicted in FIG. 7.

The system of this embodiment contains a request unit (interrogator) mounted on a field observation device and a response unit (transponder) mounted on helmet of “a friendly target”—a soldier. The interrogator mounted in conventional field observation devices, such as binoculars, night vision devices, electro-optical sights, etc. allows remotely estimating a battlefield situation by retrieving information stored in the memory of the transponder, which an individual soldier is equipped with. This embodiment mostly utilizes the solutions of the previous embodiments.

Description of Request Unit (Interrogator) of this Embodiment

Here, as depicted in FIG. 7, an observation device, such as a binocular, is equipped with the interrogator of the OCID system that comprises a small graded-index cylindrical lens 1 mounted on the binocular and optically connected to an optical-electronic unit 2 via an optical fiber 3, wherein the optical axis of the lens 1 is aligned with the axis of the binocular. This interrogator sends a laser beam 4 containing an optical coded signal, which is received by the optical-electronic transponder 5 which a friendly target—a soldier—is equipped with. When this optical signal is received, the transponder 5 sends to the request unit a coded optical response signal containing, for example, the soldier's ID information; this signal reaches the interrogator equipped with a miniature LCD screen 6 displaying (via the low-reflection semi-transparent mirror 7) the received information in observation field of the binocular in the form of a notice or pictogram.

The diagram of the interrogator of this embodiment is depicted in FIG. 8. The unit consists of two parts—a graded-index FO lens 1 attached to a field observation device (for example, binocular) and an optical-electronic unit, which contains FO splitter/combiner 3, two FO isolators 4, transmitting FO laser diode (LD) 5, FO receiver 6, driver of the FO LD 7, amplifier-former 8, processor-coder/decoder 9, flush memory 10, “blue tooth” port 11, LED screen 12, lithium battery-power source 14 and start button 15; wherein the screen 12 displays the information in the observation field of the binocular via the semi-transparent mirror as depicted in FIG. 8.

The unit works as follows:

When a person (observer) sights the observation device (binocular) on the monitored object, he touches the start button 15 that switches the unit on. The processor 9, according to program written in the flush memory 10, develops package of coded electrical pulses, which is transformed by the driver 7 into electric pulses feeding the LD 5. The length of the package can be about 10 microseconds, and it can contain 32-128-bit ID code. The laser diode 5 converts the electric pulses into modulated optical 1550-nm radiation that is transmitted to collimating lens 1 via the single-mode optic fiber 2. The lens 1 collimates the radiation into a sharp beam that illuminates the target. The transponder attached to helmet of the “friendly target” (a soldier) sends the response—a modulated optical 1550-nm IR signal—that is received by the lens 1 and transmitted to the optical-electrical unit via the optic fiber 2. This signal is transformed by FO receiver 6 into electrical pulses, which are amplified and transformed into TTL pulses by the amplifier-former 8. The pulses carrying the coded ID information are further decoded by the processor 9 and the information displayed on the screen 12. The miniature screen 12 that is built in the binocular displays the information in the observation field of the binocular by means of low-reflection (about 5-6%) semi-transparent mirror installed in the binocular. Therefore, the observer sees the monitored object and simultaneously receives the information about it. This information is written in the memory of the response unit, with which the monitored object—a soldier—is equipped. The information can contain the soldier's ID and some additional data. The program and codes written in the memory 10 can be updated via the “blue tooth” port 11.

Description of Response Unit (Transponder) of this Embodiment

This embodiment of the invention utilizes the same request unit that is used in described above IFF system of the present invention. The unit is attached to soldier's helmet as depicted in FIG. 3. The schematic and optical diagrams of the unit are depicted in FIGS. 4, 5 and 6.

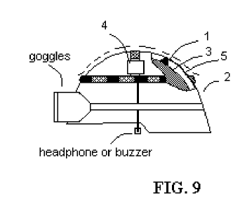

Unlike the unit utilized in IFF system of the present invention, the information sent by the transponder of this embodiment is not limited by “friendly target” signal, but contains additional data, such as soldier's ID and can, also, contain the soldier's health information and alarm signal “I wounded”. This information is written in the flash memory of the transponder (position 9 on FIG. 4), and the alert signal can be initiated by the soldier, or set automatically. In the last case, to automatically monitor soldier's health, the transponder is additionally equipped with a “health monitor” measuring pulse rate and body temperature, which is attached to the soldier's helmet and is in contact with the soldier's skin in the spot that allow performing these measurements. FIG. 9 depicts this additional part of the response unit. Here, the sensor 1 is attached to the inside surface of the soldier's helmet 2 and touches the soldier's skin 3, wherein the sensor is connected to the electronic processing unit 4 of the response unit via electric cable 5.

What is claimed is:

1. An identification friend or foe system for military small arms to determine whether a target that has been selected is a friendly target comprising:
a signal source attached to a friendly target and arranged to radiate encrypted signals,
a detection system attached to the weapon,
wherein the improvement comprises:
an optical-electronic interrogator attached to a small arm comprising an optical transmitter mounted on a sight of said small arm, which sends encrypted infrared laser beam on said friendly target, an optical receiver receiving encrypted infrared response signal emitted by said target when it has been activated by said laser beam sent by said interrogator, and a visual alarm sign mounted on the sight of said small arm activated by said received response signal,
an optical-electronic transponder attached to said target, which contains one or more optical receivers receiving encrypted infrared optical signal emitted by said interrogator, wherein this received signal activates said transponder that, being activated, transmits the encrypted infrared response signal back to said interrogator.

2. The identification friend or foe system of claim 1, wherein the interrogator of claim 1 comprises:
a fiber optical telecommunication laser optically connected to a length of single-mode optic fiber that further optically connected to a small graded-index lens transmitting the encrypted infrared laser beam of claim 1 and mounted on the sight of the small arm,
a fiber optical telecommunication receiver optically connected to a length of single-mode optic fiber that further optically connected to a small graded-index lens mounted together and coaxially with said transmitting graded-index lens on the sight of the small arm,
an optical-electronic unit mounted in convenient place of the small arm containing electronic microprocessor, flash memory and lithium battery, said fiber optical telecommunication laser, and said fiber optical telecommunication receiver, which are connected to said graded-index lenses via said single-mode optic fibers.

3. The identification friend or foe system of claim 1, wherein, to miniaturize the optics of the interrogator of claim 1 mounted on the sight of the small arm and achieve receiving of the encrypted infra-red optical signal of claim 1 emitted by the target only from area illuminated by the infrared laser beam of claim 1, the request unit of claim 1 comprises:
a single graded-index lens mounted on the sight of the small arm and optically connected to a length of single-mode optical fiber,
a fiber-optical splitter/combiner optically connected to said length of single-mode optical fiber having two 50% input/outputs,
a fiber optical telecommunication laser optically connected to a length of single-mode optic fiber,
a first fiber-optical isolator which input is connected to output of said fiber optical telecommunication laser, and output of said isolator is connected to first input/output of said splitter/combiner,
a fiber optical telecommunication receiver optically connected to a length of single-mode optic fiber,
a second fiber-optical isolator which input is connected to second input/output of said splitter/combiner, and output of said isolator is connected to input of said fiber optical receiver;
wherein,
said single graded-index lens transmits the encrypted infrared laser beam of claim 1 on the target and simultaneously receives the encrypted infrared optical signal of claim 1 emitted by the response unit of the target; so illuminated area and the area from that the signal is received are the same and determined by said single graded-index lens.

4. The transponder of claim 1 comprising:
a set of one or more optical-electronic units containing the optical receiver and the optical transmitter of claim 1, wherein the encrypted infra-red optical signal of claim 1 emitted by the interrogator is received from specific angular φ×ψ sector, where φ is the horizontal angle of said sector, and ψ is the vertical angle of said sector, and the transmitter emits the response signal in the same φ×ψ sector, therefore said set of said optical-electronic units provides complete 360-degree azimuth observation; wherein each said optical-electronic unit comprises:
an infra-red photodetector combined with cylindrical-aspheric lens that receives said encrypted infra-red optical signal emitted in said sector,
a modulated infra-red laser combined with cylindrical-aspheric lens providing irradiation of the same φ×ψ sector from that said encrypted infrared optical signal was received,
a single processing unit containing electronic drivers of said infrared lasers and receivers, a microprocessor, flash memory and lithium battery, wherein said microprocessor decodes received signal and sends coded response according to a program written in said flash memory,
a harness fixed on helmet of a soldier—friendly target, where said set of optical-electronic units and said processing units is mounted.

5. A combat identification system (CID) comprising:
an optical interrogator attached to a field observation device, such as a binocular or night vision system, which contains an optical transmitter and an optical receiver, wherein said interrogator sends an encrypted infrared laser beam on identified by said field observation device target, such as a soldier, and, when it is friendly one, receives infrared optical response signal carrying said friendly target individual information,
an optical transponder attached to said friendly target, which contains an optical transmitter and an optical receiver, wherein said unit receives encrypted infra-red optical emitted by said interrogator that activates said transponder which, being activated, emits the encrypted infra-red optical response signal carrying friendly target individual information back to said interrogator,
a display combined with said field observation device in such a way that said information appears in the field of view of said field observation device.

6. The combat identification system (CID) of claim 5, wherein the interrogator of claim 5 comprises:
a single graded-index lens mounted on the sight of the field observation device and optically connected to a length of single-mode optical fiber,
a fiber-optical splitter/combiner optically connected to said length of single-mode optical fiber having two 50% input/outputs,
a fiber optical telecommunication laser optically connected to a length of single-mode optic fiber,
a first fiber-optical isolator which input is connected to output of said fiber optical telecommunication laser, and output of said isolator is connected to first input/output of said splitter/combiner,
a fiber optical telecommunication receiver optically connected to a length of single-mode optic fiber,
a second fiber-optical isolator which input is connected to second input/output of said splitter/combiner, and output of said isolator is connected to input of said fiber optical receiver;
wherein,
said single graded-index lens transmits the encrypted infrared laser beam of claim 1 on the target and simultaneously receives the encrypted infrared optical signal of claim 1 emitted by the transponder of the target, and illuminated area and the area from that the signal is received are the same and determined by said single graded-index lens.

7. The response unit of claim 5 comprising:
a set of one or more optical-electronic units containing the optical receiver and the optical transmitter of claim 5, wherein the encrypted infrared optical signal of claim 5 emitted by the inerrogator is received from specific angular φ×ψ sector, where φ is the horizontal angle of said sector, and ψ is the vertical angle of said sector, and the transmitter emits the response signal in the same φ×ψ sector, therefore said set of said optical-electronic units provides complete 360-degree azimuth observation;
wherein each said optical-electronic unit comprises:
an infra-red photodetector combined with cylindrical-aspheric lens that receives said encrypted infrared optical signal emitted in said sector,
a modulated infrared laser combined with cylindrical-aspheric lens providing irradiation of the same φ×ψ sector from that said encrypted infrared optical signal was received,
a single processing unit containing electronic drivers of said infrared lasers and receivers, a microprocessor, flash memory and lithium battery, wherein said microprocessor decodes received signal and sends coded response according to a program written in said flash memory,
a health monitor containing a body temperature meter and a pulse rate meter mounted as a miniature sensor fastened inside of a soldier's helmet as depicted in FIG. 9 and being in contact with head skin in such a way that allows performing said measurements, wherein data obtained from these measurements are sent to said processing unit in real time and periodically updated that allows remotely estimating health conditions of said soldier,
a harness fixed on helmet of a soldier-friendly target, where said set of optical-electronic units and said processing units are mounted.
